(19) United States
(12) Patent Application Publication
(10) Pub. No.: US 2002/0090969 A1
(43) Pub. Date: Jul. 11, 2002

(54) Double-sided keypad

(76) Inventors: Lighten Tse, Boynton Beach, FL (US); Chanho Ahn, Lake Worth, FL (US); Alfredo R. Carrero, W. Palm Beach, FL (US)

Correspondence Address: MOTOROLA, INC., 800 WEST SUNRISE BOULEVARD, ROOM 1610, FORT LAUDERDALE, FL, 33322, US

(21) Appl. No.: 09/755,277

(22) Filed: Jan. 8, 2001

(51) Int. Cl. H04B 1/38

(52) U.S. Cl. 455/550; 455/90

(57) ABSTRACT

A double-sided keypad (42) comprises a first portion (52), a second portion (54), and a plurality of spacers (40). The first portion (52) comprises a first substrate (34), a first conductive plate (36) coupled on one side to the first substrate (34), and a first input/output line (37) and a second input/output line (38) that are coupled to the first conductive plate (36). The second portion (54) is symmetrically inverted from the first portion (52). The second portion (54) comprises a second substrate (48), a second conductive plate (44) coupled on one side to the second substrate (48), and a third input/output line (39) and a fourth input/output line (41) that are coupled to the second conductive plate (44). The plurality of spacers (40) are coupled between the first conductive plate (36) of the first portion (52) and the second conductive plate (44) of the second portion.

### BACKGROUND OF THE INVENTION

1. Field of the Invention

This invention relates in general to portable devices and in particular to portable devices which utilize a keypad.

2. Description of the Related Art

The trend in the electronics industry historically has been towards smaller yet more complex portable devices. As the complexity has increased, the utilization of a user interface including a keypad has followed.

Today, for example, a variety of services and features are provided within cellular telephones that require the utilization of a keypad. These services and features include phone books, calculators, wireless faxing, electronic mail (email), and short messaging service. These features in the past were typically packaged separately into separate devices. Competition in the cellular marketplace has placed increased pressure on cellular telephone manufacturers to design multifunctional devices that offer more than one of the typical services and features mentioned above. The attempt to combine such services into a single device creates a cumbersome user interface.

The desire to design multifunctional devices has led to the increasing popularity of cellular telephones with a movable housing element or “flip-phone”. Flip-phones, conventional cellular telephones with a movable housing element or “flip”, afford cellular telephone manufacturers more flexibility from a design standpoint. FIG. 1 illustrates a portable device 8 having a flip element 9. One advantage to these types of cellular telephones is that they allow the keypad of the cellular telephone to be covered, which helps prevent incidental button presses. One disadvantage to a flip-phone is that the flip must be open in order to access the keypad.

Recently, some cellular telephone manufacturers have begun selling flip-phones that have two keypads. These keypads are located on either side of the flip, and thus are referred to as double-sided keypads. A cross sectional view of a conventional double-sided keypad 10 is illustrated in FIG. 2. The conventional double-sided keypad 10 includes two conventional keypads, a first conventional keypad 19 and a second conventional keypad 21. The first conventional keypad 19 and the second conventional keypad 21 each include a plurality of conventional keys 12, a conventional substrate 14, a conductor 16, and a solder mask 18. The plurality of conventional keys 12 are coupled to the conventional substrate 14 on one side. The substrate 14 is coupled to the conductor 16 on one side. The conductor 16 is coupled between the conventional substrate 14 and the solder mask 18. The solder mask 18 is coupled to the conventional flip 20 on one side.

FIG. 3 illustrates a face-view of a conventional keypad 30. The conventional keypad 30 for example can be the first conventional keypad 19 or the second conventional keypad 21. As illustrated, the conventional keypad 30 includes the plurality of conventional keys 12 and seven (7) input/output lines 22-28. The plurality of conventional keys 12 are positioned within a three by four (3×4) matrix, where an input/output line is connected to the keys within each row and each column.

One advantage to double-sided keypads is that they simplify the user interface of the cellular telephone. Specifically, a user can dial or access the interface without opening the flip cover. Another advantage to the double-sided keypad is that the cellular telephone manufacturer can make the display larger. A larger display allows more information to be viewed when the flip is open, which allows more features to be implemented within the user interface.

One disadvantage to the construction of a conventional double-sided keypad 10 as illustrated in FIGS. 2 and 3 is the added thickness of the flip. The conventional double-sided keypad 10 typically adds to the overall size of the cellular telephone. Many cellular telephone manufacturers are attempting to decrease the size of cellular telephones, by making them smaller and more compact without losing functionality.

What is needed is an improved apparatus keypad available to a device user with the flip in the open or closed position, without increasing size.

### BRIEF DESCRIPTION OF THE SEVERAL VIEWS OF THE DRAWINGS

FIG. 1 illustrates a portable device;

FIG. 2 illustrates a cross sectional view of a conventional double-sided keypad;

FIG. 3 illustrates a face view of a conventional keypad for use in the conventional double-sided keypad of FIG. 2;

FIG. 4 illustrates a cross-sectional view of a double-sided keypad in accordance with the present invention;

FIG. 5 illustrates one embodiment of the double-sided keypad in accordance with the present invention;

FIG. 6 illustrates a top view of one embodiment of the double-sided keypad of FIG. 4;

FIG. 7 is an electronic block diagram of a keypad driver circuit;

FIG. 8 is a flowchart illustrating the operation of a keypad driver circuit for use with the double-sided keypad of FIG. 4.

### DETAILED DESCRIPTION OF THE INVENTION

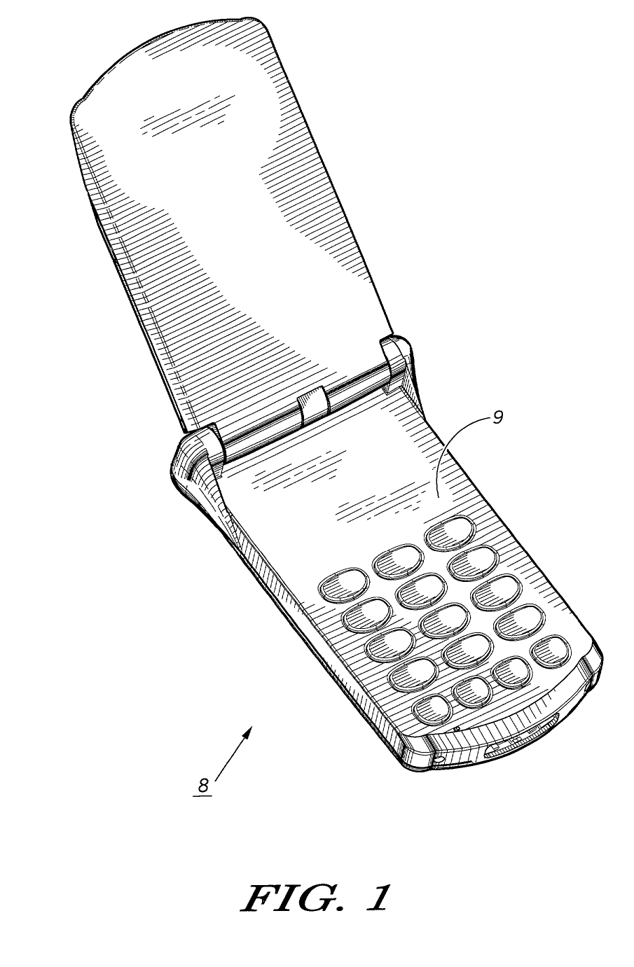

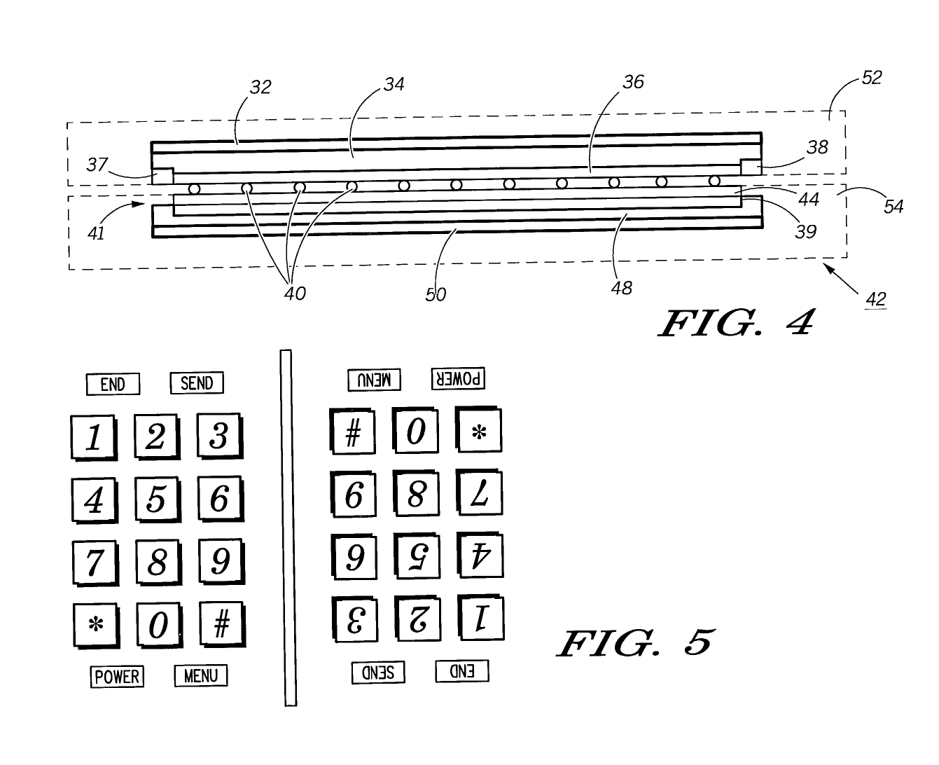

FIG. 4 illustrates a cross-sectional view of a double-sided keypad 42 for use within the portable device 8 of FIG. 1. The double-sided keypad 42 can be the flip element 9 of FIG. 1. The double-sided keypad 42 is a rectangular, flat element having dimensions consistent with the dimensions of the flip element 9 of the portable device 8, with the exception of thickness. The double-sided keypad 42 includes a first portion 52, a second portion 54, and a plurality of spacers 40. The first portion 52 includes a first label 32, a first substrate 34, a first conductive plate 36, a first input/output line 37, and a second input/output line 38. The first label 32 is coupled to the first substrate 34 on one side. The first substrate 34 is coupled between the first label 32 and the first conductive plate 36. The first conductive plate 36 is coupled between the first substrate 34 and the plurality of spacers 40. Further, the first input/output line 37 is coupled to the first conductive plate 36 on one side, while the second input/output line 38 is coupled to the first conductive plate 36 on the opposite side.

The second portion 54 is symmetrically inverted from the first portion 52. The second portion 54 includes a third input/output line 39, a fourth input/output line 41 (not shown), a second conductive plate 44, a second substrate 48, and a second label 50. The second label 50 is coupled to the second substrate 48 on one side. The second substrate 48 is coupled between the second label 50 and the second conductive plate 44. Further, the second conductive plate 44 is coupled to the plurality of spacers 40 on one side. The first conductive plate 36 and the second conductive plate 44 are coupled to the plurality of spacers 40 on opposite sides. The third input/output line 39 is coupled to the second conductive plate 44 on one side, while the fourth input/output line 41 (not shown) is coupled to the second conductive plate 44 on the opposite side. The third and fourth input/output lines (39, 41) are perpendicular to the first and second input/output lines (37, 38).

Each spacer, within the plurality of spacers 40, can be, for example, between 10 micrometers (0.00039 inches) and 20 micrometers (0.00079 inches) in diameter. The first label 32, can include a plurality of keys or buttons that are individually positioned on the first label 32, including function keys and a number pad containing individual keys numbered zero to nine (0-9). Each individual key is disposed within the first label 32. The second label 50, for example, can include a plurality of keys or buttons that are individually positioned on the second label 50, including function keys and a number pad containing individual keys numbered zero to nine (0-9). Each individual key is disposed within the second label 50. The first label 32 and the second label 50 are symmetrically inverted from each other as illustrated in FIG. 5.

Referring back to FIG. 4, the first substrate 34 can be, for example, made of plastic and approximately one millimeter (0.039 inches) thick. The second substrate 48 can be, for example, made of plastic and approximately one millimeter (0.039 inches) thick. The first input/output line 37, the second input/output line 38, the third input/output line 39, and the fourth input/output line 41 (not shown) can be, for example, made of silver. The first conductive plate 36 can be, for example, made of copper. The second conductive plate 44 can be, for example, made of copper. It will be appreciated by one of ordinary skill in the art, that the first label 32, the second label 50, the first substrate 34, the second substrate 48, the first input/output line 37, the second input/output line 38, the third input/output line 39, the fourth input/output line 41, the first conductive plate 36, and the second conductive plate 44 can be made of the material mentioned above or any other equivalent material. It will also be appreciated by one skilled in the art that the elements mentioned above can be or a dimension mentioned above or any other equivalent dimension in accordance with the present invention.

In summary, one advantage to the double-sided keypad in accordance with the present invention is minimization of required thickness. Typically, the flip elements of portable devices that contain conventional double-sided keypads are thicker than the double-sided keypad in accordance with the present invention, which is a flip element. This is primarily due to the fact that flip elements that contain conventional double-sided keypads contain two conventional keypads. This makes the flip element twice the size of a flip element that contains a single conventional keypad. While, the double-sided keypad of the present invention is the thickness of a single keypad.

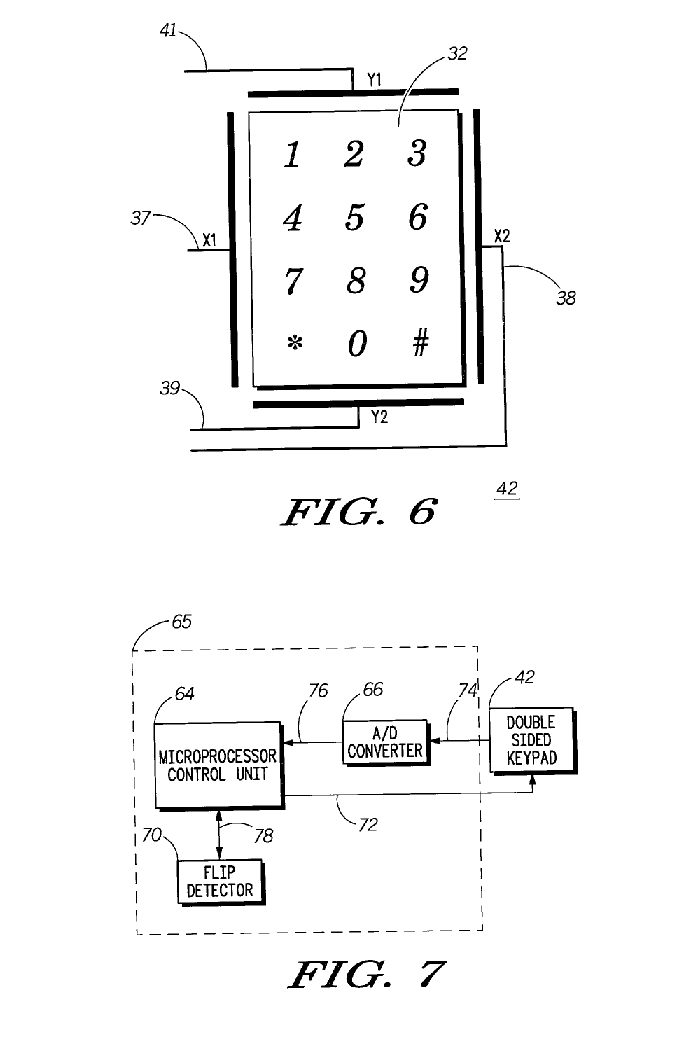

FIG. 6 illustrates a top view of one embodiment of the double-sided keypad 42 of FIG. 4. Preferably, the double-sided keypad 42 is an analog resistive touch panel. It will be appreciated by one skilled in the art that a matrix resistive touch panel or an equivalent could alternatively be used in accordance with this invention. The double-sided keypad 42 includes the first label 32, the first input/output line 37, the second input/output line 38, the third input/output line 39, and the fourth input/output line 41. The first label 32 is coupled to the first substrate 34 (not shown) on one side. The first input/output line 37 is coupled to the left side of the double-sided keypad 42, while the second input/output line 38 is coupled to the opposite side of the double-sided keypad 42. The third input/output line 39 is coupled to the bottom of the double-sided keypad 42. Further, the fourth input/output line 41 is coupled to the top of the double-sided keypad 42. The third and fourth input/output lines (39, 41) are perpendicular to the first and second input/output lines (37, 38). The input/output lines are used to provide a microprocessor control unit (MCU) 64 (see FIG. 7) with mapping information. When a key press is detected, each input/output line provides the MCU 64 with a coordinate corresponding to the position of the key press. A voltage algorithm can be used to calculate the position of the key press, where a voltage potential is applied between the first and second input/output lines (37, 38) and the same voltage potential is applied the third and fourth input/output lines (39, 41).

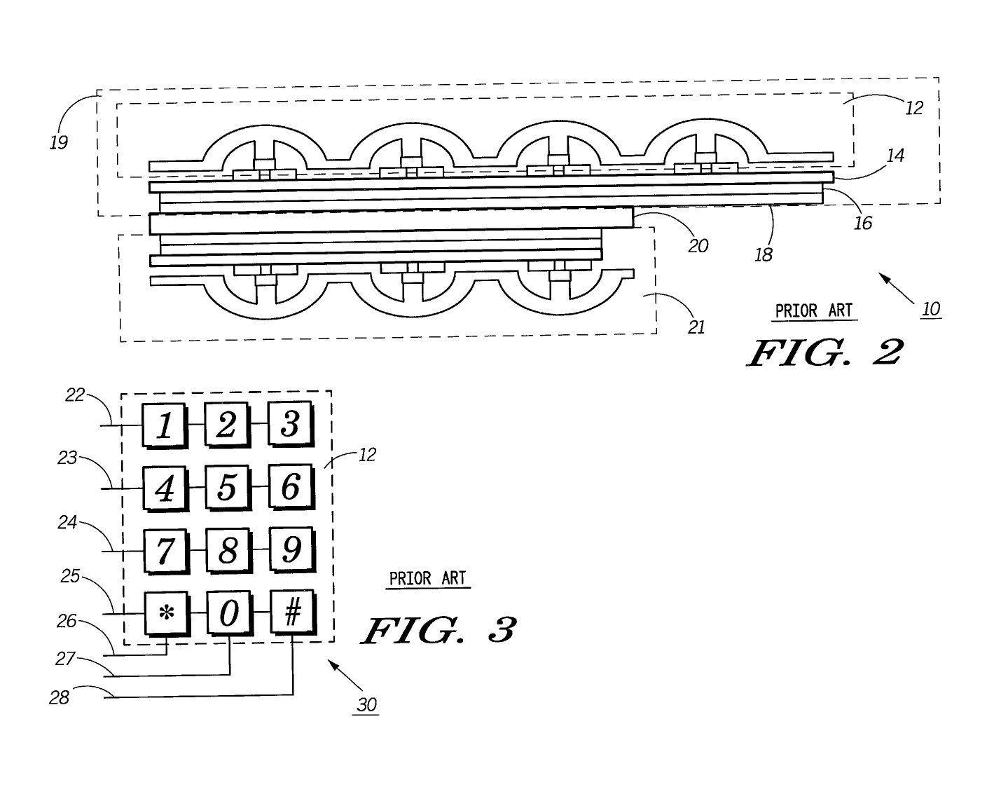

The double-sided keypad 42 in this embodiment minimizes the number of required input/output lines. For example, within the conventional double-sided keypad 10 of FIG. 2, a total of fourteen (14) connections are required for the keys mapped in a three by four (3×4) matrix, seven (7) connections for each keypad, depending on the number of keys. The double-sided keypad 42 in accordance with the present invention only requires a total of four (4) connections, for the keys mapped in a three by four (3×4) matrix, depending on the number of keys. Both sides of the double-sided keypad described in this invention use the same four connections.

FIG. 7 is an electronic block diagram of a keypad driver circuit 65 for use in the portable device 8 in accordance with the present invention. The keypad driver circuit 65 includes the MCU 64, an analog-to-digital converter (ADC) 66, and a flip detector 70. The keypad driver circuit 65 can be, for example for use within a cellular telephone. One skilled in the art will appreciate that the keypad driver circuit 65 can alternatively include a digital-to-analog converter. The flip detector 70 sends a flip detector signal 78 to the MCU 64 when the flip element 9 is moved to the open position. The MCU 64 sends a microprocessor signal 72 to the double-sided keypad 42 to apply voltage to the first input/output line 37 and the second input/output line 38. When a key is pressed, the double-sided keypad 42 receives a DC voltage that represents the value of the first coordinate. The double-sided keypad 42 then sends the keypad signal 74 that contains the first coordinate value to the ADC 66, where the signal is converted from analog to digital. After the conversion, the ADC 66 sends a converter signal 76 to the MCU 64, which contains the converted first coordinate value. The MCU 64 receives and processes the first coordinate value.

Next, the MCU 64 sends a microprocessor signal 72 to the double-sided keypad 42 to apply voltage to the third input/output line 39 and the fourth input/output line 41. The double-sided keypad 42 receives a DC voltage that represents the value of the second coordinate. The double-sided keypad 42 then sends the keypad signal 74 that contains the second coordinate value to the ADC 66, where the signal is converted from analog to digital. After the conversion, the ADC 66 sends a converter signal 76, containing the converted second coordinate value, to the MCU 64. The MCU 64 processes the converted signal, and checks for a flip detector signal 78 from the flip detector 70 to determine if the flip element 9 is in the open or closed position. The MCU 64 utilizes the first and second coordinates to calculate the position of the key press, and the flip detector signal 78 to determine which key is pressed.

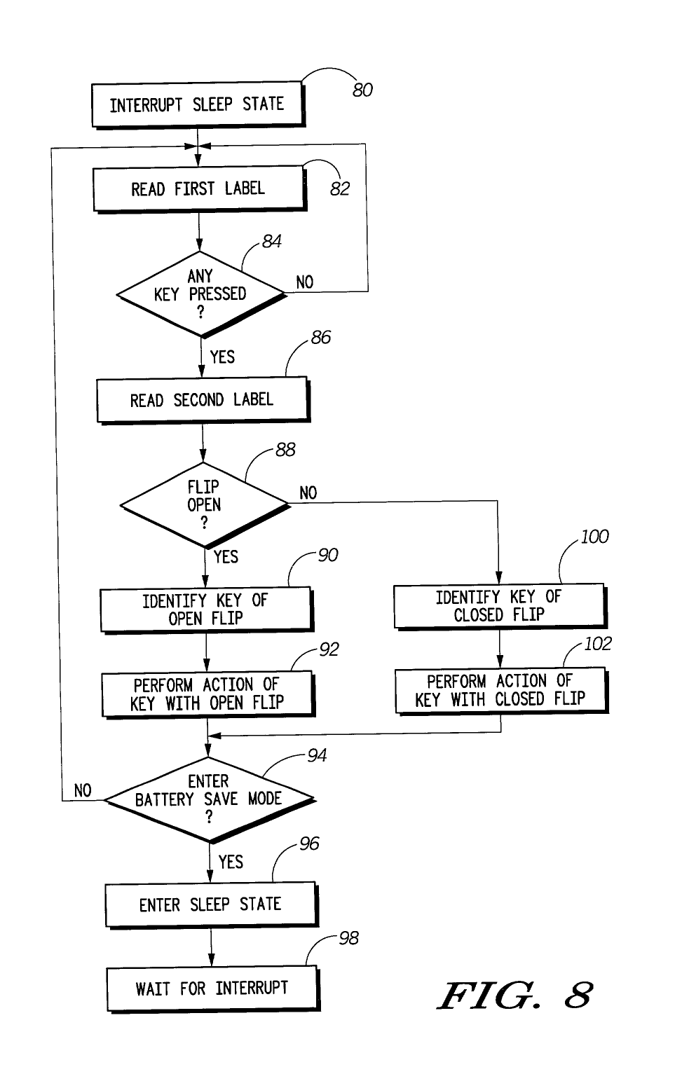

FIG. 8 is a flowchart illustrating the operation of the MCU 64 within the keypad driver circuit 65 of FIG. 7. In Step 80, the sleep state of the portable device 8 is interrupted. Next, in Step 82, the MCU 64 reads the first label 32 to retrieve the first coordinate. Next, in Step 84, the MCU 64 determines when any key has been pressed. When a key has not been pressed, the process returns to Step 82. When a key has been pressed, the process continues to Step 86 where the MCU 64 reads the second label to retrieve the second coordinate. A key press can be, for example, when a user presses the end key to end a call. Next, in Step 88, the MCU 64 determines whether the flip element 9 is open or closed. When the flip element 9 is open, the process continues to Step 90 where the key is identified. Next, in Step 92, an action is performed in response to the key press. An action can be, for example, displaying the number of the number key that is pressed or ending a call when the end key is pressed.

When, in Step 88, the flip element 9 is not open, the process continues to Step 100. In Step 100, a key press is detected while the flip element 9 is in the closed position and the key is identified. Next, in Step 102, an action is performed in response to the key press.

After the action is performed in Step 92, or in Step 102, the process continues to Step 94. In Step 94, the MCU 64 determines whether to enter battery save mode or not, as a response to inactivity. When the MCU 64 does not enter battery save mode, the process returns to Step 82. When the portable device 8 is in battery save mode, in Step 96, the portable device 8 enters a sleep state. Next, in Step 98, the portable device 8 is in a sleep state and the MCU 64 is waiting for an interrupt.

In summary, the invention as described herein provides a method for accessing the keypad with the flip in the open or closed position, without increasing size. The design offers the user a keypad on both sides of the flip, which allows the size of the display of the portable device to increase. The design also minimizes the number of required input/output lines, thereby simplifying the user interface. When a user presses a key, both labels are read, and the same input/output lines are used.

Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A double-sided keypad comprising:
a first portion, wherein the first portion comprises:
a first substrate,
a first conductive plate coupled on one side to the first substrate, and
a first input/output line and a second input/output line, wherein the first input/output line and the second input/output line are coupled to the first conductive plate;
a second portion symmetrically inverted from the first portion, wherein the second portion comprises:
a second substrate,
a second conductive plate coupled on one side to the second substrate, and
a third input/output line and a fourth input/output line, wherein the third input/output line and the fourth input/output line are coupled to the second conductive plate; and
a plurality of spacers coupled between the first conductive plate of the first portion and the second conductive plate of the second portion.

2. A double-sided keypad as recited in claim 1, wherein the first portion further comprises a first label, and further wherein the first substrate is coupled between the first label and the first conductive plate.

3. A double-sided keypad as recited in claim 1, wherein the second portion further comprises a second label, and further wherein the second substrate is coupled between the second label and the second conductive plate.

4. A double-sided keypad as recited in claim 1, wherein the first input/output line and the second input/output line are oppositely positioned.

5. A double-sided keypad as recited in claim 4, wherein the third input/output line and the fourth input/output line are oppositely positioned.

6. A double-sided keypad as recited in claim 5, wherein the third input/output line and the fourth input/output line are perpendicular to the first input/output line and the second input/output line.

7. A portable device comprising:
a double-sided keypad, wherein the double-sided keypad comprises:
a first portion, wherein the first portion comprises:
a first substrate,
a first conductive plate coupled on one side to the first substrate, and
a first input/output line and a second input/output line, wherein the first input/output line and the second input/output line are coupled to the first conductive plate,
a second portion symmetrically inverted from the first portion, wherein the second portion comprises:
a second substrate,
a second conductive plate coupled on one side to the second substrate, and
a third input/output line and a fourth input/output line, wherein the third input/output line and the fourth input/output line are coupled to the second conductive plate, and
a plurality of spacers coupled between the first conductive plate of the first portion and the second conductive plate of the second portion; and
a keypad driver circuit coupled to the double-sided keypad, wherein the keypad driver circuit provides a signal to the portable device in response to determining the state of the double-sided keypad.
